(19) United States
(12) Patent Application Publication
(10) Pub. No.: US 2018/0029253 A1
(43) Pub. Date: Feb. 1, 2018

(54) METHOD AND APPARATUS FOR PROCESSING PART

(71) Applicant: General Electric Company, Schenectady, NY (US)

(72) Inventor: Edward James Balaschak, Simpsonville, SC (US)

(21) Appl. No.: 15/221,206

(22) Filed: Jul. 27, 2016

(51) Int. Cl. B29C 35/02

(52) U.S. Cl. CPC B29C 35/02

(57) ABSTRACT

In one embodiment, a method of manufacturing a part includes placing a die mold and a part substance in a heating zone of a microwave heating apparatus, and subjecting the die to microwave radiation. The die mold supports at least a portion of the part substance and includes a first dopant, which has a greater microwave radiation heating susceptibility than the die mold. In another embodiment, a die mold material includes a plastic and a dopant, the dopant having a greater microwave radiation heating susceptibility than the plastic. In another embodiment, a method of manufacturing a part includes placing a part substance in a microwave radiation heating zone, and subjecting the part substance to microwave radiation to heat the dopant. The part substance includes a dopant, the dopant having a first microwave radiation heating susceptibility greater than a second microwave radiation heating susceptibility of the part substance.

### BACKGROUND OF THE INVENTION

The subject matter disclosed herein relates to manufacturing processes and related components, and more particularly, to heating processes and related components that facilitate heating targeted areas using microwave radiation.

Conventional heating used in the manufacturing of parts, such as ceramic parts, typically involves a convective or radiative heating, such as with a convective or radiative kiln or oven. In this sort of oven, heat can be created by electrical resistance or combustion. This conventional heating is used for various processes, each with a different purpose. For example, these processes can include removing a die mold used to mold a physical shape of a ceramic part, debinding a molded ceramic mixture that will form the final ceramic part in order to remove binding agent(s), and sintering the molded ceramic to harden the ceramic part.

Conventional heating used during each of these processes can yield negative results due to the limited control over where heat is applied within a heating zone of an oven. Typically, heat is applied to the entire surface (uniformly or non-uniformly) of whatever items are placed in the heating zone. The items then conduct heat internally. Heating in this fashion results in a thermal differential within each item, and/or between each item. Further, portions of any particular item, or entire items, within the heating zone, can be unavoidably and undesirably heated. During removal of a plastic die mold from a molded ceramic substance, for example, conventional heating can undesirably heat the molded ceramic substance beyond a particular temperature necessary to burn off the die mold, which can undesirably alter the integrity of the molded ceramic substance. To avoid overheating the molded ceramic substance, the heating source might be kept below a particular temperature, which can increase processing times, lower processing efficiency, and increase costs.

During debinding of a ceramic body, for another example, a thermal differential within the ceramic body can result. If the thermal differential between any two portions of the ceramic body is too high, it can lead to cracking or other structural damage, and/or non-uniform debinding, which would result in non-uniform physical and chemical properties. If the external portions heat more quickly than the internal portions, as is prone to happen with radiant and convection heating, binding agent can be trapped within the internal portions. The trapped binding can create excessive pressure, which creates cracks, voids, or other defects. One way to combat these problems with thermal differentials is to heat the ceramic body more slowly, or in steps, to minimize the degree to which the heating of the internal portions of the ceramic body lags behind the heating of the external portions of the ceramic body. Again, though, slower heating translates to longer processing times, decreased processing efficiency, and higher processing costs.

In another example, where a ceramic body that has already been at least partially processed (e.g., molded, debinded, and/or sintered) acts as a mold for a second ceramic substance, or the second ceramic substance is otherwise added to the processed ceramic body, the ceramic body can be undesirably heated when debinding or sintering the ceramic substance. Each of the ceramic body and the ceramic substance can also experience an undesirable thermal differential.

### BRIEF DESCRIPTION OF THE INVENTION

A microwave radiation heating method is provided that can decrease firing times, increase manufacturing efficiency, and/or reduce cost, while facilitating the ability to target microwave radiation heating in desired items or portions of items within a microwave heating zone.

A first aspect of the disclosure provides a method of manufacturing a part, the method including placing a die mold and a part substance in a heating zone of a microwave heating apparatus, the die mold supporting at least a portion of the part substance, the die mold including a first dopant, the first dopant having a greater microwave radiation heating susceptibility than the die mold; and subjecting the die mold to microwave radiation to heat the first dopant.

A second aspect of the disclosure provides a die mold material, the die mold material including a plastic; and a dopant within or on the plastic, the dopant having a greater microwave radiation heating susceptibility than the plastic.

A third aspect of the disclosure provides a method of manufacturing a part, the method including placing a part substance in a microwave radiation heating zone, the part substance including a dopant, the dopant having a first microwave radiation heating susceptibility greater than a second microwave radiation heating susceptibility of the part substance; and subjecting the part substance to microwave radiation to heat the dopant.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic illustration of a basic microwave radiation heating system for manufacturing a part according to various embodiments of the invention;

FIG. 2 is a flow chart showing a method of manufacturing a part, according to various embodiments; and

FIG. 3 is a flow chart showing another method of manufacturing a part, according to various embodiments.

The detailed description explains embodiments of the invention, together with advantages and features, by way of example with reference to the drawings.

### DETAILED DESCRIPTION OF THE INVENTION

Microwave radiation heating is a heating method alternative to conventional radiative or convective heating. Microwave radiation heating involves applying energy directly within a body to be heated by delivering electromagnetic radiation in the microwave wavelength range uniformly across a heating zone and the body in the heating zone. Polarized molecules in materials containing the polarized molecules rotate to align their poles with an electromagnetic field of the electromagnetic waves. Other charged ions can also be forced to flow. As the electromagnetic field alternatives with the oscillating waves, the polarized molecules rotate to realign, and the charged ions reverse direction of flow. Because the electromagnetic waves in the microwave wavelength range oscillate at a high frequency, these waves cause the polarized molecules to rotate continuously, and the charged ions to flow back and forth quickly. Temperature is directly related to the kinetic energy, or the motion, of the atoms or molecules of a material. As the molecules rotate and the ions flow, the temperature rises. The motion, through friction and contact with other molecules, causes further motion of the other molecules, which further facilitates heating.

Because varying materials have varying amounts of free charged ions and polarized molecules, varying materials heat under exposure to microwave radiation in varying degrees. Particular locations in the heating zone or in any bodies in the heating zone can be targeted for reaction with the microwave radiation by adding microwave-reactive material in those locations. Contrary to conventional methods, which subject the surface of the body in the heating zone to the radiant heat energy, microwave heating subjects an entire cross section of any body in the heating zone to the microwave radiation.

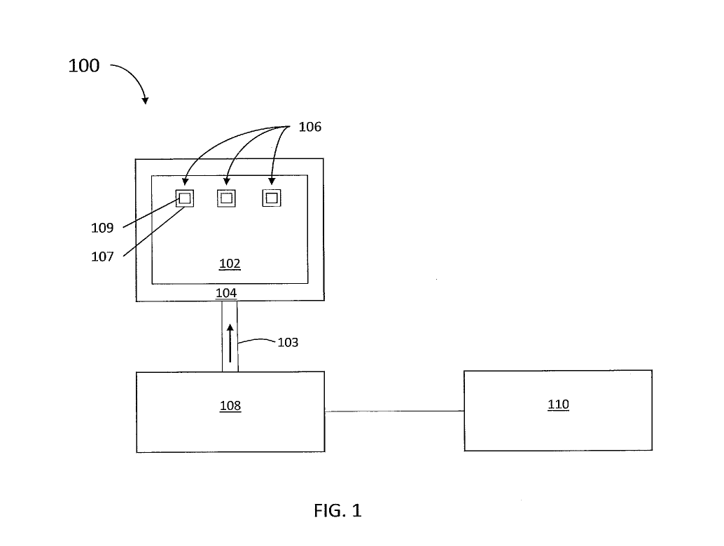

FIG. 1 shows a basic microwave radiation heating system 100 for processing a part according to various embodiments. Microwave radiation heating system 100 comprises a microwave heating zone 102, comprising a thermally insulated wall 104. Within microwave heating zone 102 can be located one or more items 106 to be heated. Items 106 can include, for example, a die mold 107, and a part substance 109, such as a ceramic substance, and/or a metal substance. The part substance 109 can be solid, liquid, or something in between, such as a slurry (e.g., ceramic slurry), which can be formed into a desirable shape and heated to reach a more solid, sturdy form. Items 106 could also include other types of materials besides ceramics or metals that would benefit from a firing or heating process. Die mold 107 can be shaped from a plastic, plastic-based, or other die mold material suitable for functioning as a die mold. Die mold material can be in the form of any shape, such as a block, powder, crystals, or string. Die mold material can be extrudable, printable (e.g., using a 3D printer), or machinable to form die mold 107. Die mold 107 can be any predetermined shape suitable to mold at least a portion of part substance 109 to the predetermined shape. Part substance 109 can abut die mold 107, be supported by die mold 107, be at least partly contained in die mold 107, or fill a concave or hollow portion of die mold 107.

A microwave generator 108 is coupled directly or indirectly to microwave heating zone 102. A waveguide 103 is one means for coupling microwave generator 108 to microwave heating zone 102 and directing microwave radiation to heating zone 102. System 100 can include a microwave power source/controller 110 for supplying and/or adjusting microwave power and other characteristics. Microwave generator 108 can include any now known or later developed magnetron, and may have an adjustable power feature, which can be controlled by controller 110. Microwave generator 108 could have power levels ranging up to 75 kW or higher. The frequency of incident microwaves generated can be between the range of 0.915 GHz to 10 GHz. 0.915 GHz to 2.45 GHz is the designated industrial band in the United States, while in other countries, wavelengths up to 10 GHz are known to be utilized. About 300 GHz to about 1 GHz has been found to be an effective range in some applications. Furthermore, the power of the incident microwaves need not necessarily be greater than an amount sufficient to raise the temperature of items 106, or desired locations in items 106, to an effective temperature to perform the desired process. The effective temperature is the temperature items 106, or desired portions of items 106, are intended to be heated to yield the desired outcome. The effective temperature depends, at least in part, on the desired process (e.g., die mold removal, debinding, etc.), and the desired outcome of the process. A heating profile of the heating zone 102 can vary to achieve the effective temperature, depending at least in part, on the material composition and shape of items 106. The heating profile represents characteristics (e.g., power, frequency) of microwave radiation applied to heating zone 102 over time—from an initial time to an end time, or the heat over time applied to die mold 107 or part substance 109 in heating zone 102.

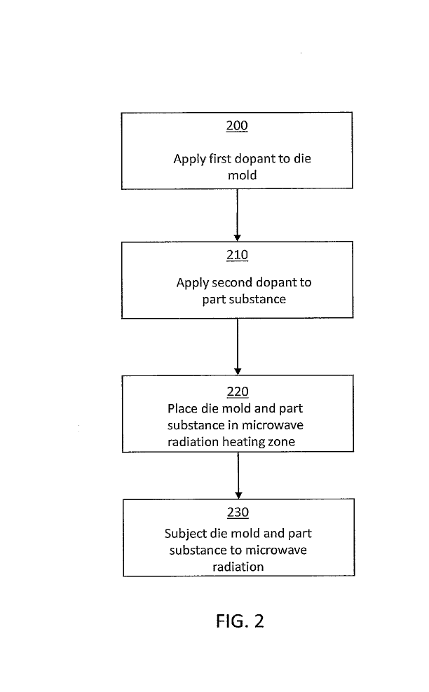

FIG. 2 is a flow chart showing a method of manufacturing a part, according to various embodiments. Some of the steps described with reference to FIG. 2 can be performed, for example, in conjunction with microwave radiation heating system 100 illustrated in FIG. 1. Step 200 includes applying a first dopant to a die mold 107. The first dopant can be a material such as carbon or silicon carbide that, compared to the material of die mold 107 and/or part substance 109 molded by die mold 107, has a relatively high susceptibility to heating by exposure to microwave radiation. Microwave radiation heating susceptibility can be due to an absorbency of microwave radiation, a dielectric heating constant, or another quality that causes the material to heat during exposure to microwave radiation. “Microwave radiation heating susceptibility” shall mean a characteristic of any material or body to increase in temperature as a result of exposure to any designated intensity and frequency of microwave radiation. If a first material has a greater microwave radiation heating susceptibility than a second material, the first material will heat faster when exposed to microwave radiation than the second material. The microwave radiation heating susceptibility of the first dopant can be at least as high as the microwave radiation heating susceptibility of the die mold material, of any material or body in which the first dopant is intended to accelerate or increase heating, and/or of any material that is intended to have heating minimized.

The first dopant can be applied to the surface of die mold 107 or alternatively, integrated within the body of die mold 107. First dopant can be applied to a portion, or all, of the surface in any known manner, such as by coating with a brush, application of a spray, deposition, etc. Applying the first dopant to the surface of die mold 107 can facilitate faster heating of die mold 107 on or toward the outside of die mold 107, which can be beneficial in instances where microwave radiation tends to heat internal areas at a quicker rate than external areas, or where part substance 109 is supported by, contained inside, die mold 107. In the latter case, increasing the heating toward the outside of die mold 107 can enable the outside of die mold 107 to get hotter faster, relative to the internal portions of die mold 107 closer to part substance 109. The external portions of die mold 107 can burn off first, while internal portions of part substance 109 are shielded from unnecessary or excessive heat. Internal portions of die mold 107 adjacent or contacting part substance 109 can heat second, assisted by conduction through die mold 107, with less overall heat that can conduct to part substance 109. Applying the first dopant to the surface of die mold 107 can also be a relatively inexpensive option, or a practical option when it is not possible or practical to integrate the first dopant into the body of die mold 107.

The first dopant can alternatively be applied to die mold 107 by integrating the first dopant into the body of die mold 107. The first dopant can be integrated into a portion, or all, of the body of die mold 107 by any known manner, such as by mixing the first dopant into a fluid material that is used to form the portion, or all of, die mold 107, ion implanting, in-situ deposition, injection, etc. The first dopant can be mixed into die mold 107 material or at least a portion of die mold 107 at 0-15 percent by weight, or at higher concentrations up to 50% by weight or more. The first dopant can be applied in a uniform concentration, or in varying concentrations to different portions of die mold 107. It can be relatively inexpensive and efficient from a manufacturing perspective, in some instances, to add first dopant directly to a fluid die mold material before forming the shape of, and curing, die mold 107. Such a die mold material can be used as “ink” in a 3D printer, for example, to print die mold 107.

Additionally, according to step 210, a second dopant can optionally be applied to a part substance (e.g., a ceramic slurry) that is shaped by die mold 107. The second dopant can be the same dopant as the first dopant applied to die mold 107, with a same or different concentration or volume, or the second dopant can be a different dopant altogether. The combinations of type, amount, and method of application (e.g., applied to the surface or integrated throughout part substance 109) can vary greatly depending on the desired outcome. For example, the second dopant might be particularly reactive to a different range of microwave radiation than the first dopant, so the microwave radiation heating source 100 can apply microwave wavelengths that will heat the first dopant but affect the second dopant relatively little, then separately apply different microwave wavelengths that heat the second dopant. In this way, applying dopant to different materials can be combined into a single stage, and/or multiple firing processes can be combined to save time and cost, while reducing the chance for damage to the fired product. For example, the first dopant can be chosen to accelerate heating at a faster rate than the second dopant, such that die mold 107 heats more quickly and burns off before part substance 109 overheats. In this manner, dopant can be applied to part substance 109 at a convenient time when it is more fluid, and utilized to heat part substance 109 during a later firing process after die mold 107 is removed.

Applying the second dopant to part substance 109 can be accomplished by applying the second dopant to the surface of part substance 109 or integrating the second dopant within part substance 109, as discussed above with respect to die mold 107. As with the first dopant, the second dopant can be applied uniformly or non-uniformly, to just a portion of part substance 109, just a portion of the surface of part substance 109, all of the surface, or all of the part substance 109.

Applying the second dopant to part substance 109, such as a ceramic part substance, can increase the heating rate, shorten the firing process, reduce cost, and increase heating uniformity. Some dopants, such as carbon, cannot be burned off or removed once added to the part, though, and the dopant can weaken the structure of the final, fired part, and/or add weight to it. Accordingly, in cases where the second dopant would add weight to the final, fired part, a cost benefit analysis would determine whether the benefit in manufacturing efficiency and heating uniformity possible by adding second dopant to part substance 109 would outweigh the possible loss in strength and gain in weight in the finished part.

For a debinding process, it might be advantageous to apply the second dopant to the binding agent, and then to add the binding agent to part substance 109 (e.g., ceramic slurry). Doping the binding agent first can focus the microwave heating more directly on or around the binding agent, which can increase the speed of debinding while minimizing the heat applied to the ceramic.

Step 220 includes placing die mold 107 and part substance 109 in the microwave radiation heating zone 102 of microwave radiation heating system 100, die mold 107 supporting at least a portion of part substance 109. Die mold 107 shapes part substance 109, so die mold 107 and part substance 109 are placed in the heating zone 102 adjacent each other. Die mold 107 can at least partially contain part substance 109.

Step 230 includes subjecting die mold 107 and part substance 109 to microwave radiation. As discussed above, the heating profile can vary greatly depending on many factors and the desired outcome. The power supplied to microwave radiation heating system 100 should be enough to emit microwave radiation with an intensity, timing, and frequency according to the intended heating profile.

It is conceived to use a hyrid oven that includes both microwave radiation heating and radiant heating. When it is beneficial to heat external portions of part substance 109 or die mold 107 earlier relative to internal portions, for example, rather than applying microwave radiation susceptible dopant to the external portions, radiant heating can be used to supplement or balance microwave radiation heating. Further, if microwave radiation heats internal portions too quickly relative to external portions, radiant heating can be applied externally, again, to balance the heating with what is desired. In some cases, when it is desired to heat an internal portion and an external portion in separate temporal phases, it can be desirable to alternate between microwave and radiant heating. Radiant heating can be combined with microwave radiation heating in a variety of other situations as well, depending on the results particularly desired.

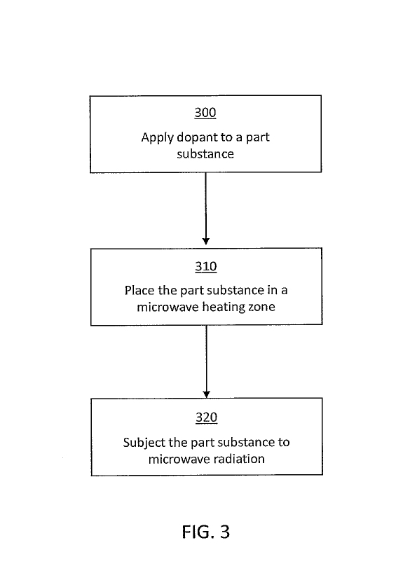

FIG. 3 is a flow chart showing another method of manufacturing a part, according to various embodiments. Some of the steps described with reference to FIG. 3 can be performed, for example, in conjunction with the microwave radiation heating system 100 illustrated in FIG. 1. Step 300 includes applying dopant to a part substance 109, the dopant having a first microwave radiation heating susceptibility greater than a second microwave radiation heating susceptibility of part substance 109. Part substance 109 can be a ceramic or a metal as discussed above, and can have a binding agent. Part substance 109 can be a slurry requiring a die mold 107 or other support, or part substance 109 can be processed to a point (e.g., debinded, cured, or sintered) such that no die mold 107 or other support is necessary, and part substance 109 can be the only item 106 in the heating zone 102. The dopant can be applied as discussed with regard to step 200 of FIG. 2.

Step 310 includes placing part substance 109 in microwave radiation heating zone 102. In the case that part substance 109 is a slurry, such as a ceramic slurry, part substance 109 can be added (e.g., adjacent or attached) to a body that is further processed than part substance 109. For example, the body may have already undergone a debinding or sintering process, while part substance 109 may have yet to undergo debinding or sintering. The body can act in a similar capacity as die mold 107 to mold at least a portion of part substance 109, provide support for part substance 109, and/or contain at least a portion of part substance 109.

Step 320 includes subjecting part substance 109 to microwave radiation to heat the dopant to an effective temperature of the dopant. As discussed above, the firing of doped part substance 109 can increase the rate of heating and decrease the time for any particular firing process, be it debinding, sintering, or otherwise, while also achieving a more uniform heat that decreases the thermal differential within different portions of the ceramic substance. If part substance 109 is added to a body, then part substance 109 can be more efficiently heated without unduly heating the body, which would increase the risk of detrimental structural or chemical changes to the body.

It is understood that in the flow diagram shown and described herein, other steps may be performed while not being shown, and the order of steps can be rearranged according to various embodiments. Additionally, intermediate steps may be performed between one or more described steps. The flow of steps shown and described herein is not to be construed as limiting of the various embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of manufacturing a part, the method comprising:
placing a die mold and a part substance in a heating zone of a microwave heating apparatus, the die mold supporting at least a portion of the part substance, the die mold including a first dopant, the first dopant having a greater microwave radiation heating susceptibility than the die mold; and
subjecting the die mold to microwave radiation to heat the first dopant.

2. The method of claim 1, further comprising applying the first dopant to the die mold prior to placing the die mold and the part substance in the heating zone.

3. The method of claim 1, wherein the first dopant is on a surface of the die mold.

4. The method of claim 1, wherein the first dopant is within a body of the die mold.

5. The method of claim 1, further comprising applying a second dopant to the part substance.

6. The method of claim 5, wherein a percent by weight of the second dopant applied to the part substance differs from a percent by weight of the first dopant applied to the die mold.

7. The method of claim 5, wherein the first dopant is a different type than the second dopant.

8. The method of claim 1, wherein subjecting the die to microwave radiation includes adjusting an intensity or wavelength of the microwave radiation.

9. The method of claim 1, wherein subjecting the die mold to microwave radiation debinds the part substance.

10. The method of claim 1, wherein subjecting the die to microwave radiation removes the die mold from the part substance.

11. The method of claim 1, wherein the part substance comprises at least one selected from the group consisting of ceramic and metal.

12. A die mold material, the die mold material comprising:
a plastic; and
a dopant within or on the plastic, the dopant having a greater microwave radiation heating susceptibility than the plastic.

13. The die mold material of claim 12, wherein the dopant comprises at least one element selected from the group consisting of carbon and silicon carbide.

14. The die mold material of claim 12, wherein the dopant is within the plastic.

15. The die mold material of claim 12, wherein the die mold material is configured in a predetermined shape having a concavity to contain and mold at least a portion of a part substance.

16. A method of manufacturing a part, the method comprising:
placing a part substance in a microwave radiation heating zone, the part substance including a dopant, the dopant having a first microwave radiation heating susceptibility greater than a second microwave radiation heating susceptibility of the part substance; and
subjecting the part substance to microwave radiation to heat the dopant.

17. The method of claim 16, wherein the part substance comprises at least one selected from the group consisting of ceramic and metal.

18. The method of claim 16, wherein the dopant comprises at least one element selected from the group consisting of carbon and silicon carbide.

19. The method of claim 16, further comprising applying the dopant to a binding agent, and applying the binding agent to the part substance after applying the dopant to the binding agent.

20. The method of claim 16, further comprising supporting at least a portion of the part substance on a sintered part in the microwave radiation heating zone, the part substance being unsintered.
